(19) United States
(12) Patent Application Publication
(10) Pub. No.: US 2003/0160738 A1
(43) Pub. Date: Aug. 28, 2003

(54) Display device

(76) Inventors: Yoshiyuki Kaneko, Hachioji (JP); Yuuichi Kijima, Chousei (JP); Susumu Sasaki, Chiba (JP); Shigemi Hirasawa, Chiba (JP); Kenji Miyata, Hitachinaka (JP)

Correspondence Address: Christopher E. Chalsen, Esq., Milbank, Tweed, Hadley & McCloy LLP, 1 Chase Manhattan Plaza, New York, NY, 10005-1413, US

(21) Appl. No.: 10/351,871

(22) Filed: Jan. 27, 2003

(30) Foreign Application Priority Data
Feb. 22, 2002 (JP) 2002-046401

(51) Int. Cl. G09G 1/06

(52) U.S. Cl. 345/10

(57) ABSTRACT

In a display device, a distance (a gap) between cathode lines (electron sources) and control electrodes is made uniform and a stray discharge attributed to the electron sources attached to the cathode lines which are exposed through between the neighboring plate-like control electrodes can be prevented. A display device comprises a back panel and a front panel on an inner surface of a back substrate. The back panel includes a plurality of cathode lines which have electron sources on an inner surface of the back panel and extend in parallel to each other, and a plurality of plate-like control electrodes which have electron passing holes which allow electrons emitted from the electron sources to pass therethrough to a front panel side, cross the cathode lines in a non-contact manner and are formed in parallel to each other. The front panel includes anodes and phosphors formed on an inner surface of a front substrate which faces the back substrate. Between the cathode lines formed on the back substrate, strip-like adhesive agent layers which fix the plate-like control electrodes with holding the plate-like control electrodes at a given distance from the cathode lines are provided. Further, insulation covering layers are formed over the cathode lines between the neighboring plate-like control electrodes.

### BACKGROUND OF THE INVENTION

The present invention relates to a display device which utilizes the emission of electrons into vacuum, and more particularly to a display device which forms a gap with high accuracy between electron sources and control electrodes which control an emission quantity of electrons from the electron sources thus realizing a stable control of an electron emission quantity which leads to the enhancement of display characteristics of the display device.

A color cathode ray tube has been popularly used conventionally as a display device which exhibits excellent properties such as high luminance and high definition. However, along with a demand for high image quality in recent information processing apparatuses and television broadcasting, a demand for a planar display (panel display) which is light-weighted and requires a small space while ensuring favorable properties such as high luminance and high definition is increasing.

As a typical example of such a planar display, a liquid crystal display device, a plasma display device and the like have been commercialized. Further, as the planar display device which can realize the high luminance, various types of panel-type display devices including a display device which makes use of emission of electrons from an electron source into vacuum (hereinafter, referred to as an electron emission type display device or a field emission type display device), an organic EL display which is characterized by its low power consumption and the like are expected to be commercialized soon.

Among such panel-type display devices, as the field emission type display device, a display device having an electron emission structure which is proposed by C. A. Spindt et al, a display device having a metal-insulator-metal (MIM) type electron emission structure, a display device having an electron emission structure which makes use of an electron emission phenomenon based on a quantum theory tunneling effect (also referred to as a surface conductive type electron source), a display device which makes use of an electron emission phenomenon possessed by a diamond film, a graphite film. carbon nanotubes or the like have been known.

The field emission type display device includes a back panel which forms a field emission type electron source and control electrodes on an inner surface thereof and a front panel which forms an anodes and a luminescent material on an inner surface which faces the back panel in an opposed manner, wherein the display device is constituted by laminating both panels while inserting a sealing frame between inner peripheries of both panels and by evacuating the inside defined by the back panel, the front panel and the sealing frame.

The back panel includes a plurality of cathode lines having electron sources on a back substrate which is preferably made of glass or alumina, and control electrodes which are provided in a state that the control electrodes cross the cathode lines by way of an insulation layer. An emission quantity (including ON and OFF of emission) of electrons from the electron sources is controlled based on a potential difference between the cathode lines and the control electrodes.

Further, the front panel includes anodes and phosphors on a front substrate which is formed of a light transmitting material such as glass or the like. The sealing frame is fixed to inner peripheries of the back panel and the front panel using an adhesive agent such as frit glass. The degree of vacuum inside the back panel, the front panel and the sealing frame is set to 10⁻⁵ to 10⁻⁷ Torr, for example. A gap defined between the back panel and the front panel is held by interposing gap holding members in a display region.

An insulation layer is interposed between the cathode lines provided to the back panel and the control electrodes which cross the cathode lines and electron passing holes (also referred to as grid holes) are formed in each crossing portion of the control electrodes. The electron passing holes allow the electrons emitted from the electron sources to pass therethrough to the anode side. On the other hand, the electron sources are provided above the crossing portions of the cathode lines and the insulation layers are removed at portions corresponding to holes of the control electrodes. The above-mentioned electron sources are formed of, for example, carbon nanotubes (CNT), diamond-like carbon (DLC) and other field emission cathodes.

The electron sources are formed in the vicinity of positions right below the holes formed in the control electrodes. Further, the arrangement of electron sources is not limited to one electron source for one pixel and a plurality of electron sources may be arranged for one pixel.

The electrons emitted from the back panel impinge on the phosphors of the front panel which faces the back panel in an opposed manner. Then, light corresponding to the light emitting characteristics of the phosphors is emitted to the outside of the front panel thus enabling the display device to perform its function.

In this type of display device, the back panel is formed such that the cathode lines are formed on the back substrate using a thin film patterning technique or the like, the insulation layer having a given thickness is formed over the cathode lines by coating, and portions of the insulation layer above the pixel portions are removed. Then, while leaving the electron passing holes, the control electrodes are formed on the insulation layer using a vapor deposition method or a spattering method.

Since the insulation layer is formed by applying a resin material using a screen printing method, it is difficult to make a thickness of the insulation layer uniform. That is, it is impossible to make the thickness of the insulation layer uniform without generating irregularities over an entire surface of the display region. Although it is necessary to control the gap defined between the cathode lines and the control electrodes at an level of μm, since the control electrodes are formed following a surface shape of the insulation layer and hence, the irregularities of the thickness of the insulation layer in the periphery of the electron passing holes formed in the control electrodes generate the irregularities of the gap defined between the cathode lines and the control electrodes leading to the irregularities of electron emission performance among respective pixels.

Further, since the insulation layer is present at the crossing portion between the cathode line and the control electrode, capacitance is formed. The irregularities of thickness of the insulation layer bring about the irregularities of the capacitance and, at the same time, when the thickness of the insulation layer is increased, this impedes the high frequency driving. Accordingly, it is preferable to make the thickness of the insulation layer as small as possible and it is most desirable to adopt the constitution which makes the insulation layer unnecessary. With respect to the prior art, these matters still remain as obstacles in the commercialization of display devices and constitute tasks to be solved.

### SUMMARY OF INVENTION

Accordingly, it is a first object of the present invention to make a distance (gap) between cathode lines and control electrodes uniform. It is the second object of the present invention to provide a high-quality display device which can prevent a stray discharge attributed to electron sources attached to the cathode lines exposed between the neighboring plate-like control electrodes.

To achieve the above-mentioned first object, the display device according to the present invention solves the above-mentioned task by adopting plate-like control electrodes which are formed of plate-like metal plates or the like, for example, as the above-mentioned control electrodes. Here, as typical means which mount the plate-like control electrodes on a back substrate with a given distance with respect to the cathode lines, following constitutions are adopted.

(1). In a display device comprising:

a back panel including a back substrate, a plurality of cathode lines which are formed on an inner surface of the back substrate, have electron sources and extend in a first direction, and a plurality of control electrodes in which electron passing holes which allow electrons emitted from the electron sources to pass therethrough are formed, which are not in contact with the cathode lines, extend in a second direction which crosses the first direction and controls electron emission characteristics of the electron sources; and

a front panel including a front substrate and anodes and phosphors formed on an inner surface of the front substrate which faces the back substrate, the improvement is characterized in that

the control electrodes are plate-like control electrodes, and

the back panel includes strip-like adhesive agent layers which are provided in regions between a plurality of cathode lines and between the back substrate and the plate-like control electrodes, and fix the plate-like control electrodes with holding a given distance between the plate-like control electrode and the cathode lines, and the strip-like adhesive agent layers extend in the first direction and fix at least two out of the plurality of plate-like control electrodes in common.

(2). In the constitution (1), the plate-like control electrode includes first protrusions which protrude toward the back substrate side at portions corresponding to positions between the neighboring cathode lines, and

at least some of the strip-like adhesive agent layers are formed between the first protrusions and the back substrate.

(3). In the constitution (1) or (2), the plate-like control electrode includes second protrusions which protrude toward the back substrate side at peripheral portions thereof along the second direction.

(4). In the constitution (3), the back panel includes strip-like adhesive agent layers which extend in the second direction between the back substrate and the second protrusions.

(5). In a display device comprising:

a back panel including a back substrate, a plurality of cathode lines which are formed on an inner surface of the back substrate, have electron sources and extend in a first direction, and a plurality of control electrodes in which electron passing holes which allow electrons emitted from the electron sources to pass therethrough are formed, which are not in contact with the cathode lines, extend in a second direction which crosses the first direction and control electron emission characteristics of the electron sources; and

a front panel including a front substrate and anodes and phosphors formed on an inner surface of the front substrate which faces the back substrate, the improvement is characterized in that

the control electrodes are plate-like control electrodes, include recessed portions which reduce a thickness of the plate-like control electrodes at cathode-line-side regions where the electron passing holes are formed, and include peripheral protrusions which protrude toward the back substrate side at peripheral portions along the second direction, and

the back panel includes strip-like adhesive agent layers which are provided between the back substrate and the peripheral protrusions, and extend in the second direction and fix the plate-like control electrodes with holding a given distance between the plate-like control electrode and the cathode lines.

(6). In the constitution (5), the strip-like adhesive agent layers which extend in the second direction are formed in common with respect to the neighboring plate-like control electrodes.

(7). In the constitution (5) or (6), the plate-like control electrodes include inter-cathode-line protrusions which protrude toward the back substrate side at portions thereof corresponding to positions between the neighboring cathode lines.

(8). In any one of the constitutions (5) to (7), the strip-like adhesive agent layer which extends in the first direction is formed between the neighboring cathode lines.

(9). In any one of the constitutions (5) to (8), insulation layers are formed between the strip-like adhesive agent layers and the back substrate.

Due to the above-mentioned constitutions described in the above-mentioned constitutions (1) to (9), it is possible to make the distance (gap) between the cathode lines and the control electrodes uniform so that a high-quality display device which exhibits the uniform luminance distribution over a display region can be obtained.

Further, as the means which achieves the second object of the present invention, the display device according to the present invention can dissolve the occurrence of a stray discharge by covering portions of the cathode lines which are exposed through between a plurality of the plate-like control electrodes with an insulation covering layer. To describe typical means, the means has following constitutions.

(10). In a display device comprising:

a back panel including a back substrate, a plurality of cathode lines which are formed on an inner surface of the back substrate, have electron sources and extend in a first direction, and a plurality of control electrodes in which electron passing holes which allow electrons emitted from the electron sources to pass therethrough are formed, which are not in contact with the cathode lines, extend in a second direction which crosses the first direction and control electron emission characteristics of the electron sources; and

a front panel including a front substrate and anodes and phosphors formed on an inner surface of the front substrate which faces the back substrate, the improvement is characterized in that

the control electrodes are plate-like control electrodes, and

the back panel includes an insulation covering layer which covers portions of the cathode lines which are exposed through between the plurality of plate-like control electrodes.

(11). In the constitution (10), assuming a distance from a surface of the cathode line to the electron passing holes formed in the plate-like control electrode at a region where the cathode line and the plate-like control electrode crosses as d1 and a thickness of the insulation covering layer over the cathode lines in a region other than the region where the cathode line and the plate-like control electrode crosses as d2, a relationship d2<d1 is established.

(12). In the constitution (10) or (11), the plate-like control electrode includes first protrusions which protrude toward the back substrate side at portions thereof corresponding to positions between the neighboring cathode lines and the first protrusions hold a distance between the cathode lines and the electron passing holes.

(13). In any one of the constitutions (10) to (12), the plate-like control electrode includes second protrusions which protrude toward the back substrate side at peripheral portions thereof along the second direction and the second protrusions hold a distance between the cathode lines and the electron passing holes.

(14). In the constitution (10) or (11), the back panel includes support column members which hold the plate-like control electrodes with respect to the back substrate with a given distance in regions between the cathode lines formed on the back substrate.

Due to the above-mentioned constitutions (10) to (14), it is possible to provide a high-quality display device which can prevent a stray discharge attributed to electron sources attached to the cathode lines exposed between the neighboring plate-like control electrodes.

Further, in the constitutions (1) to (14), three cathode lines may be formed into one group corresponding to respective pixels of R, G, B for color display and recessed portions or protrusions are formed in the plate-like control electrode for every grouped cathode lines. Further, two cathode lines or four or more cathode lines may be formed into a group, and recessed portions or protrusions similar to the above-mentioned portions or protrusions can be formed in the plate-like control electrode for every such grouped cathode lines or for every desired combination of these groups.

It is needless to say that the present invention is not limited to the above-mentioned constitutions and constitutions of embodiments which are explained hereinafter and various modifications are conceivable without departing from the technical concept of the present invention.

### BRIEF DESCRIPTION OF THE DRAWINGS

FIG. 1 is a plan view of a back panel side for explaining the constitution of one embodiment of a display device according to the present invention.

FIG. 2 is a cross-sectional view taken along a line A-A′ in FIG. 1.

FIG. 3 is a plan view of a back panel side for explaining the constitution of another embodiment of the display device according to the present invention.

FIG. 4 is a cross-sectional view taken along a line A-A′ in FIG. 3.

FIG. 5 is a cross-sectional view taken along a line B-B′ in FIG. 3.

FIG. 6 is a plan view of a back panel side for explaining the constitution of another embodiment of the display device according to the present invention.

FIG. 7 is a cross-sectional view taken along a line A-A′ in FIG. 6.

FIG. 8 is a cross-sectional view taken along a line B-B′ in FIG. 6.

FIG. 9 is a cross-sectional view of a back panel side for explaining the constitution of another embodiment of the display device according to the present invention.

FIG. 10 is a cross-sectional view of a back panel side for explaining the constitution of another embodiment of the display device according to the present invention.

FIG. 11 is an explanatory view of a planar shape of narrow strip-like adhesive agent layers in the embodiments shown in FIG. 6 to FIG. 8 and FIG. 9 and FIG. 10.

FIG. 12 is an explanatory view of another planar shape of the narrow strip-like adhesive agent layers in the embodiments shown in FIG. 6 to FIG. 8 and FIG. 9 and FIG. 10.

FIG. 13 is a plan view for explaining the arrangement of cathode lines and plate-like control electrodes formed on a back panel.

FIG. 14 is a plan view of a back panel side for explaining the constitution of another embodiment of the display device according to the present invention.

FIG. 15 is a plan view showing only an insulation covering layer by taking out such a layer from FIG. 14.

FIG. 16 is a cross-sectional view taken along a line A-A′ in FIG. 14.

FIG. 17 is a cross-sectional view taken along a line B-B′ in FIG. 14.

FIG. 18 is a plan view of the back panel-side for explaining the constitution of another embodiment of the display device according to the present invention.

FIG. 19 is a cross-sectional view taken along a line A-A′ in FIG. 18.

FIG. 20 is a cross-sectional view taken along a line B-B′ in FIG. 18.

FIG. 21 is a plan view of the back panel-side for explaining the constitution of another embodiment of the display device according to the present invention.

FIG. 22 is a plan view of the back panel-side for explaining the constitution of another embodiment of the display device according to the present invention.

FIG. 23 is a cross-sectional view taken along a line A-A′ in FIG. 22.

FIG. 24 is a cross-sectional view taken along a line B-B′ in FIG. 22.

FIG. 25 is an equivalent circuit for explaining one example of a driving method of a display device according to the present invention.

### DESCRIPTION OF THE PREFERRED EMBODIMENTS

Preferred embodiments of a display device according to the present invention are explained hereinafter in detail in conjunction with attached drawings.

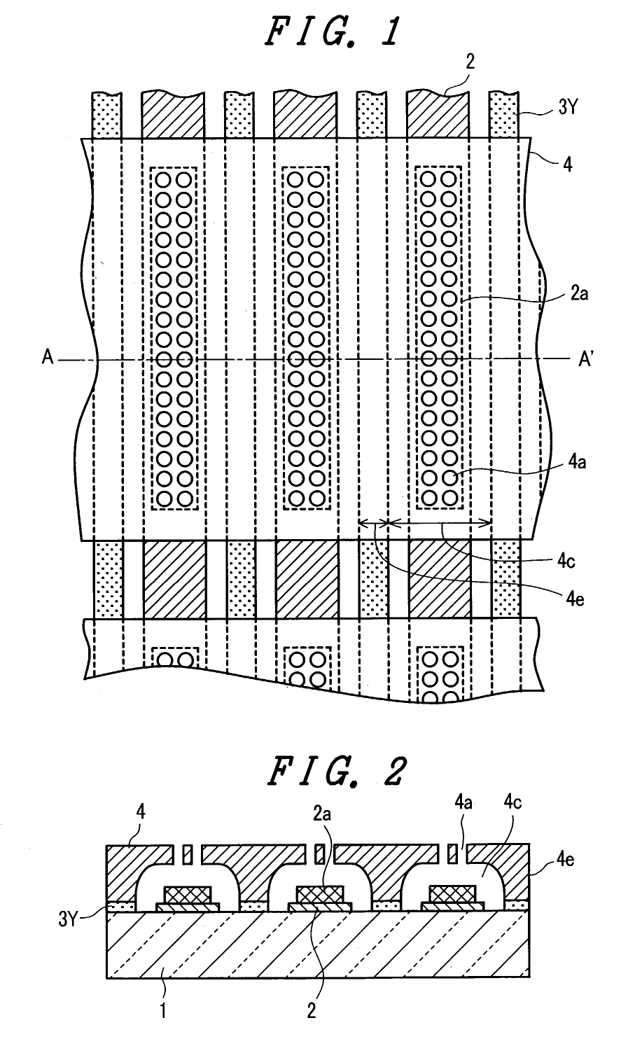

FIG. 1 is a plan view of a back panel side for explaining the constitution of one embodiment of a display device according to the present invention. Further, FIG. 2 is a cross-sectional view taken along a line A-A′ in FIG. 1. Numeral 2 indicates cathode lines formed on an inner surface of a back substrate 1, numeral 2a indicates electron sources (for example, carbon nanotubes), and numeral 3 indicates narrow strip-like adhesive agent layers, wherein since the narrow strip-like adhesive agent layers 3 are arranged in the extending direction (Y=the first direction) of the cathode lines 2 and hence, the narrow strip-like adhesive agent layers are indicated by numeral 3Y. Further, numeral 4 indicates plate-like control electrodes, numeral 4a indicates electron passing holes, and numeral 4c indicates recessed portions. Although a plurality of electron passing holes 4a are formed for one pixel in this embodiment, one electron passing hole 4a may be formed for one pixel.

In this embodiment, the plate-like control electrodes 4 are adopted as control electrodes. Different from thin-film control electrodes formed on an insulation layer using a vapor deposition method or a spattering method conventionally, these plate-like control electrodes 4 are control electrodes formed of plate members which are manufactured as separate members by applying etching or the like to metal plates, for example. When these plate-like control electrodes 4 are used, since the plate-like control electrodes 4 per se have the rigidity, even when an insulation layer is formed below the plate-like control electrode 4, the irregularities of a gap defined between the cathode lines 2 and the plate-like control electrodes 4 attributed to the irregularities of thickness of the insulation layer in the vicinity of the electron passing holes 4a can be reduced whereby it is possible to realize the favorable electron emission characteristics.

Further, even when the insulation layers are formed, it is possible to form the insulation layers while obviating regions where the cathode lines 2 and the control electrodes 4 cross each other and hence, a drawback attributed to the capacitance generated between the cathode lines 2 and the control electrodes 4 can be reduced whereby the fast response can be realized.

Further, in this embodiment, as shown in FIG. 2, in the portions of the plate-like control electrodes 4 which cross the cathode lines 2, the thickness of the plate-like control electrodes 4 are reduced thus forming the recessed portions 4c at the cathode line 2 side and the electron passing holes 4a are formed at bottom portions of these recessed portions 4c. Due to such a constitution, compared to a case in which a thickness of the plate-like control electrode 4 is large, it is possible to form the electron passing holes 4a accurately and, at the same time, a gap defined between the plate-like control electrodes 4 and the cathode lines 2 can be accurately controlled whereby the favorable electron emission characteristics can be realized.

Further, along with the formation of the recessed portions 4c, protrusions which protrude toward the back substrate 1 side are formed on the plate-like control electrodes 4. By forming these protrusions and supporting the plate-like control electrodes 4 using these protrusions, it is possible to eliminate an insulation layer whereby the favorable electron emission characteristics can be realized.

Further, even when insulation layers are formed below these protrusions, it is possible to make a thickness of the insulation layers small while holding the gap defined between the cathode lines 2 and the electron passing holes 4a at a given value. The smaller the thickness of the insulation layers, the irregularities of the thickness are decreased and hence, the favorable electron emission characteristics can be realized.

In this embodiment, each protrusion is formed at a portion corresponding to a position between the neighboring cathode lines 2 and constitutes a first protrusion (inter-cathode-line protrusion) 4e.

In this embodiment, the strip-like adhesive agent layer 3Y is formed between the plate-like control electrodes 4 having such first protrusions 4e and the back substrate 1 thus fixing the plate-like control electrode 4 to the back substrate 1 using the adhesive agent layer 3Y.

Although these strip-like adhesive agent layers 3Y constitute a type of insulation layers, these adhesive agent layers 3Y are different from usual insulation layers with respect to a point that the adhesive agent layers 3Y fix the plate-like control electrodes 4. A thickness of the strip-like adhesive agent layers 3Y can be suitably adjusted and may be set smaller than a thickness of the cathode lines 2 as shown in FIG. 2.

The strip-like adhesive agent layers 3Y are arranged such that they are disposed parallel to the extending direction Y of the cathode lines 2 and each strip-like adhesive agent layer 3Y is arranged in an extended manner between the neighboring cathode lines 2. The plate-like control electrode 4 which crosses the cathode lines 2 is fixed to the back substrate 1 at both sides of each cathode line 2 using the strip-like adhesive agent layers 3Y having a given thickness (height).

Here, when the recessed portions 4c are not formed in the plate-like control electrode 4, the strip-like adhesive agent layers 3Y are provided to portions which obviate positions where the cathode lines 2 are formed. In this case, to ensure a given gap, the thickness of the strip-like adhesive agent layer 3Y is set larger than the thickness of the strip-like adhesive agent layer 3Y of a case in which the recessed portions 4c are formed in the plate-like control electrode 4.

Further, although the recessed portion 4c is also formed in a peripheral portion along the extending direction of the plate-like control electrode 4 in FIG. 1, this recessed portion 4c may be made small and it may be possible to form a second protrusion (peripheral protrusion) 4f (not shown in the drawing) which protrudes toward the back substrate 1 at each peripheral portion along the extending direction of the plate-like control electrode 4 besides the first protrusion 4e. In this case, although it is necessary to adjust the thickness of the strip-like adhesive agent layers 3Y such that the plate-like control electrode 4 and the cathode lines 2 are not brought into contact with each other, since the gap between the back substrate 1 and the electron passing holes 4a can be adjusted by the recessed portions 4c, there is no problem even when the thickness of the strip-like adhesive agent layers 3Y is reduced compared to a case in which the recessed portions 4c are not formed in the plate-like control electrode 4.

Further, it is preferable to form the strip-like adhesive agent layer 3Y using a printing method. A thickness of the strip-like adhesive agent layer at the time of printing is determined by taking the reduction of height due to pressure applied at the time of fixing the plate-like control electrode 4 into consideration.

Here, the strip-like adhesive agent layers 3Y may be formed in the extending direction intermittently or in a discontinuous manner. However, it is possible to form the strip-like adhesive agent layers 3Y more accurately at the time of printing by forming the strip-like adhesive agent layers 3Y continuously compared to a case in which the strip-like adhesive agent layers 3Y are formed as islands. Accordingly, it is desirable to form each strip-like adhesive agent layer 3Y such that the strip-like adhesive agent layer 3Y has a length which enables fixing of at least two or more plate-like control electrodes 4 in common.

According to this embodiment, the distance between the cathode lines 2 and the electron passing holes 4a of the plate-like control electrodes 4 is set by the thickness of the strip-like adhesive agent layers 3Y and the distance can be adjusted to a uniform value over the whole area of a display region by setting this thickness to a given value. Accordingly, it is possible to obtain the uniform display characteristics over the whole area of the display region.

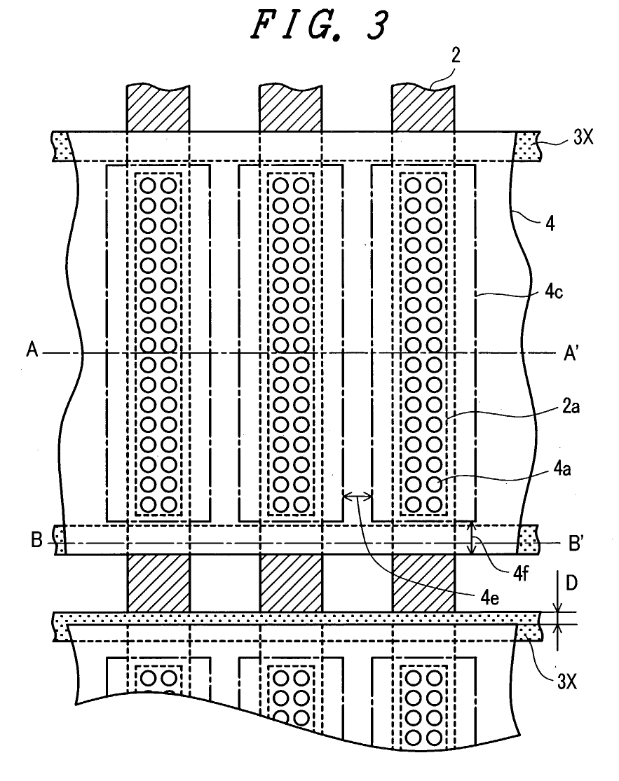

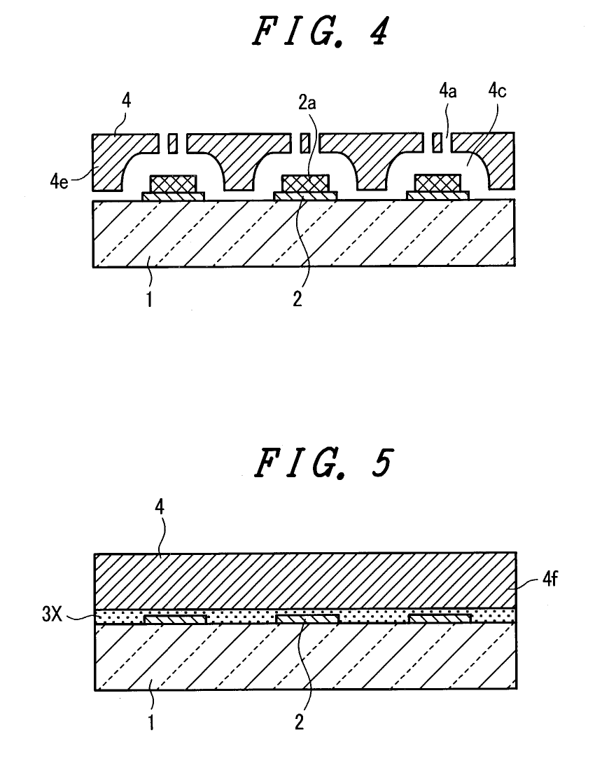

FIG. 3 is a plan view of a back panel side for explaining the constitution of another embodiment of the display device according to the present invention. Further, FIG. 4 is a cross-sectional view taken along a line A-A′ in FIG. 3 and FIG. 5 is a cross-sectional view taken along a line B-B′ in FIG. 3. Numeral 3X indicates strip-like adhesive agent layers which extend in the second direction X which crosses the first direction Y. Numerals in FIG. 3 which are equal to those shown in FIG. 1 and FIG. 2 indicate parts having identical functions.

In this embodiment, recessed portions 4c are formed in the plate-like control electrodes 4 while leaving peripheral portions of the plate-like control electrodes 4 in the extending direction of the plate-like control electrodes 4 as it is. Accordingly, in addition to the first protrusions 4e which are formed at portions corresponding to positions between the cathode lines 2, second protrusions (peripheral protrusions) 4f which protrude toward the back substrate 1 side are also formed at peripheral portions of the plate-like control electrodes 4 along the extending direction of the plate-like control electrodes 4. Here, the strip-like adhesive agent layers 3X are formed to prevent the plate-like control electrodes 4 and the cathode lines 2 from coming into contact with each other. As indicated by a symbol D in FIG. 3, the plate-like control electrode 4 and the strip-like adhesive agent layer 3X may be displaced slightly from each other. Since a gap between a back substrate 1 and electron passing holes 4a can be adjusted by the provision of recessed portions 4c, it is possible to reduce a thickness of the strip-like adhesive agent layers 3X compared to a case in which the recessed portions 4c are not formed in the plate-like control electrodes 4.

The strip-like adhesive agent layers 3X of this embodiment fix the plate-like control electrodes 4 to the back substrate 1 such that the strip-like adhesive agent layers 3X are disposed in the extending direction of the plate-like control electrodes 4 and are arranged between the second protrusions 4f formed at both peripheries of the plate-like control electrodes 4 and the back substrate 1. As shown in FIG. 4, a gap is formed between the first protrusion 4e of the plate-like control electrode 4 and the back substrate 1. Here, the strip-like adhesive agent layer 3Y may be formed in the gap as shown in FIG. 1.

When the recessed portions 4c are not formed in the plate-like control electrode 4, to ensure a given gap, the thickness of the strip-like adhesive agent layer 3X is set larger than the thickness of the strip-like adhesive agent layer 3X in a case in which the recessed portions 4c are formed in the plate-like control electrodes 4.

Further, it is preferable to form the strip-like adhesive agent layer 3X using a printing method. A thickness of the strip-like adhesive agent layer at the time of printing is determined by taking the reduction of height due to pressure applied at the time of fixing the plate-like control electrode 4 into consideration.

Here, the strip-like adhesive agent layers 3X maybe formed in the extending direction in a discontinuous manner.

According to this embodiment, in addition to the advantageous effects obtained by the above-mentioned embodiment, by arranging the strip-like adhesive agent layers 3X in the above-mentioned manner, it is possible to ensure the mounting tolerance D of the plate-like control electrode 4 in the first direction Y and hence, the assembling of the plate-like control electrodes 4 can be facilitated.

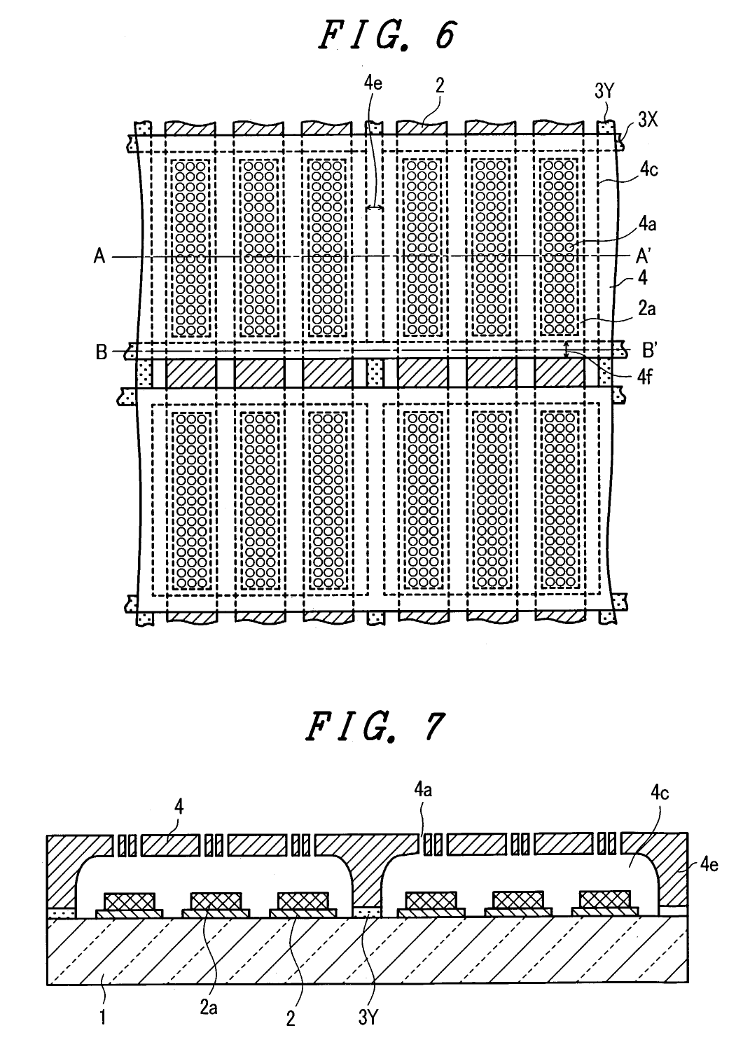

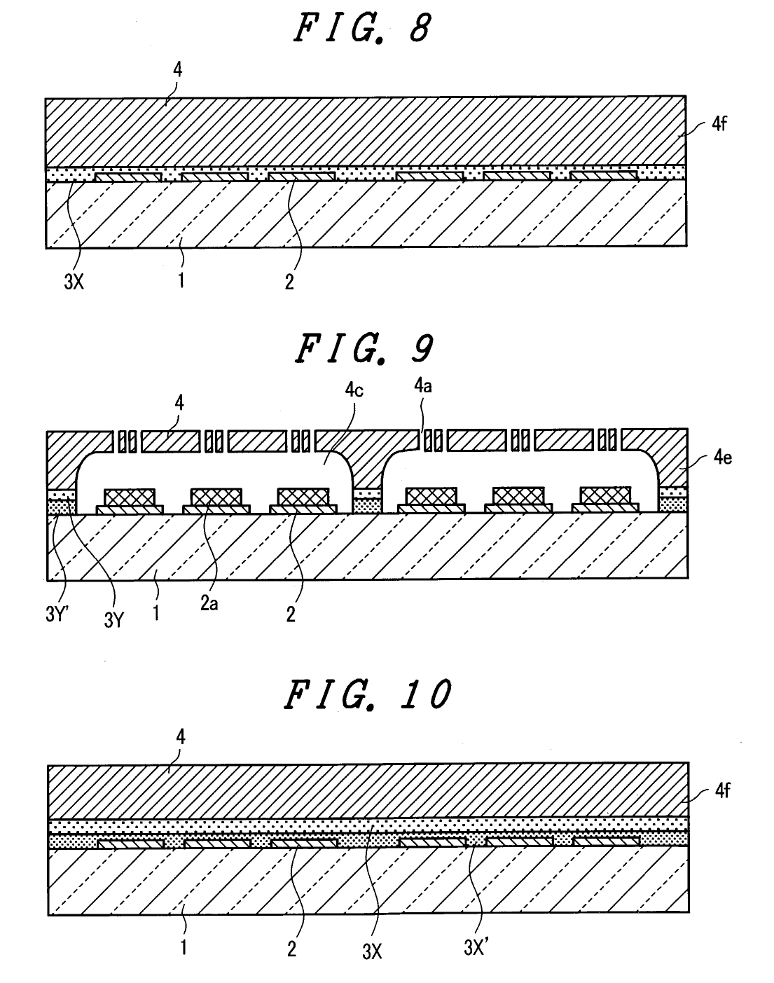

FIG. 6 is a plan view of a back panel side for explaining the constitution of the another embodiment of the display device according to the present invention. Further, FIG. 7 is a cross-sectional view taken along a line A-A′ in FIG. 6 and FIG. 8 is a cross-sectional view taken along a line B-B′ in FIG. 6. Symbols in this embodiment which are equal to those in the above-mentioned respective embodiments indicate parts having identical functions. This embodiment adopts plate-like control electrodes 4 each of which has recessed portions 4c for every three cathode lines 2 which are formed into a group corresponding to respective pixels of R, G, B for color display. That is, the plate-like control electrode 4 corresponds to a control electrode which is formed by combining strip-like adhesive agent layers 3 of respective embodiments explained in conjunction with FIG. 1 and FIG. 3.

As shown in FIG. 7 and FIG. 8 both of which are cross-sectional views, in this embodiment, the strip-like adhesive agent layers 3Y and 3X are respectively arranged between the first protrusions 4e of the recessed portions 4c of the plate-like control electrodes 4 and the back substrate 1 and between the second protrusions 4f of the recessed portions 4c of the plate-like control electrodes 4 and the back substrate 1. Here, the grouping is not limited to every three cathode lines 2 and the grouping may be made with respect to every two cathode lines, every four or more cathode lines or a combination thereof.

When the recessed portions 4c are not formed in the plate-like control electrodes 4, thicknesses of the strip-like adhesive agent layers 3X, 3Y are set larger than the corresponding thicknesses when the recessed portions 4c are formed in the plate-like control electrodes 4.

Further, it is preferable to form the strip-like adhesive agent layers 3X, 3Y by a printing method. The thicknesses of the strip-like adhesive agent layers 3X, 3Y at the time of printing are determined by taking the reduction of height due to pressure applied at the time of fixing the plate-like control electrode 4 into consideration.

Here, it is not always necessary to form both of the strip-like adhesive agent layers 3X, 3Y and either one of them may be formed. Further, one of the strip-like adhesive agent layers 3X, 3Y may be formed in the extending direction in a discontinuous manner.

Further, the number of the first protrusions 4e is reduced by performing the grouping and hence, the alignment is facilitated. Further, the distance between the cathode lines 2 may differ within the group as well as between the groups. In this case, it is possible to ensure spaces for arranging the first protrusions 4e and the strip-like adhesive agent layers 3Y so that the mounting tolerance is increased. Further, as shown in FIG. 1. it may be possible to adopt the structure in which the recessed portion 4c is extended to the periphery thus eliminating the second protrusions 4f.

FIG. 9 and FIG. 10 are cross-sectional views of the back panel side for explaining the constitution of another embodiment of the display device according to the present invention. Since this embodiment constitutes a modification of the embodiment described in conjunction with FIG. 6 to FIG. 8 and hence, FIG. 9 corresponds to FIG. 7 and FIG. 10 corresponds to FIG. 8. This embodiment is characterized in that dielectric insulation layers 3X′, 3Y′ are respectively formed below the strip-like adhesive agent layers 3X, 3Y in the embodiment shown in FIG. 6 to FIG. 8.

Although both of the strip-like adhesive agent layers 3X, 3Y are insulators, with the provision of these dielectric insulation layers 3X′, 3Y′, it is possible to perform the gap adjustment and, at the same time, it is possible to obviate short-circuiting between the plate-like control electrodes 4 and the cathode lines 2 at the time of mounting the plate-like control electrodes 4. As a material of these dielectric insulation layers 3X′, 3Y′, it is preferable to use a glass paste containing PbO as a main component, for example and the material is patterned by a photolithography method or the like. For example, when an inorganic adhesive layer made of glass frit or the like is used as the strip-like adhesive layers 3X, 3Y and a thickness of these layers is equal to or less than 4 μm, a thickness of the dielectric insulation layers 3X′, 3Y′ is 10 μm to 20 μm.

This embodiment is applicable to respective embodiments explained in conjunction with FIG. 1 to FIG. 5.

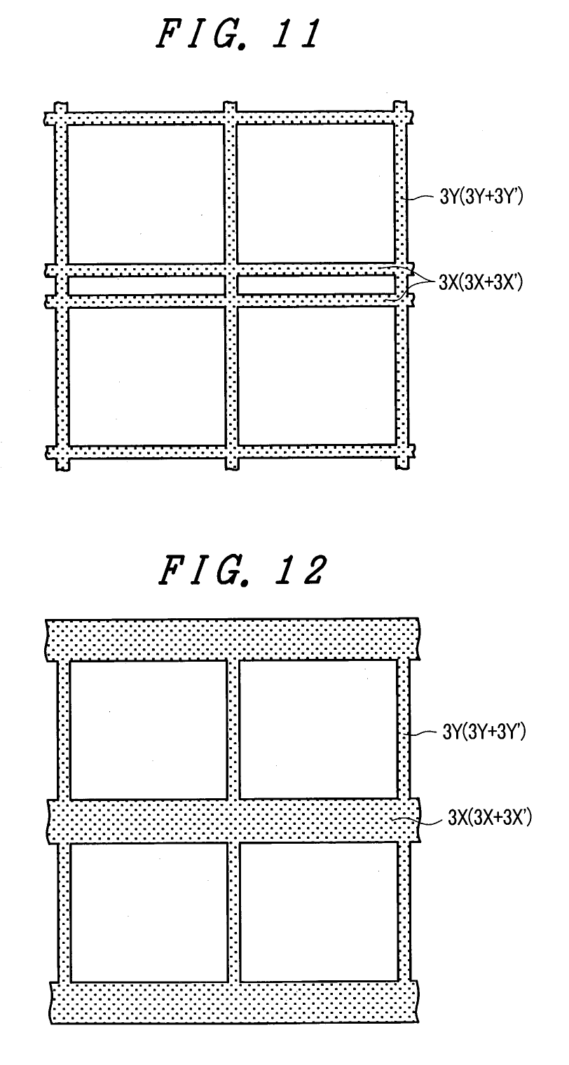

FIG. 11 is an explanatory view of a planar shape of the strip-like adhesive agent layers according to the embodiments shown in FIG. 6 to FIG. 8 and FIG. 9 and FIG. 10. Further, FIG. 12 is an explanatory view of another planar shape of the strip-like adhesive agent layers according to the embodiments shown in FIG. 6 to FIG. 8 and FIG. 9 and FIG. 10. With respect to the strip-like adhesive agent layers 3X, 3Y or the laminar structure formed of the strip-like adhesive agent layers 3X, 3Y and the dielectric insulation layers 3X′, 3Y′, they are formed into a planar shape having a matrix shape shown in FIG. 11 or FIG. 12.

Particularly, as shown in FIG. 12, by increasing a width of the strip-like adhesive agent layers 3X formed in the second direction X such that they are arranged in common with the neighboring plate-like control electrodes 4, it is possible to increase the mounting tolerance of the plate-like control electrodes 4. Further, as will be explained later, it is also possible to prevent the stray discharge. This embodiment is also applicable to the embodiment shown in FIG. 3. Here, in the same manner as the above-mentioned respective embodiments, the respective strip-like adhesive agent layers (or the laminated structure of the strip-like adhesive agent layer and the dielectric insulation layer) may be formed discontinuously or one of them may be formed discontinuously.

As has been explained in conjunction with respective embodiments heretofore, it is possible to set the distance between the plate-like control electrodes 4 and the cathode lines 2 uniform over the whole area of the display region and the display quality can be enhanced.

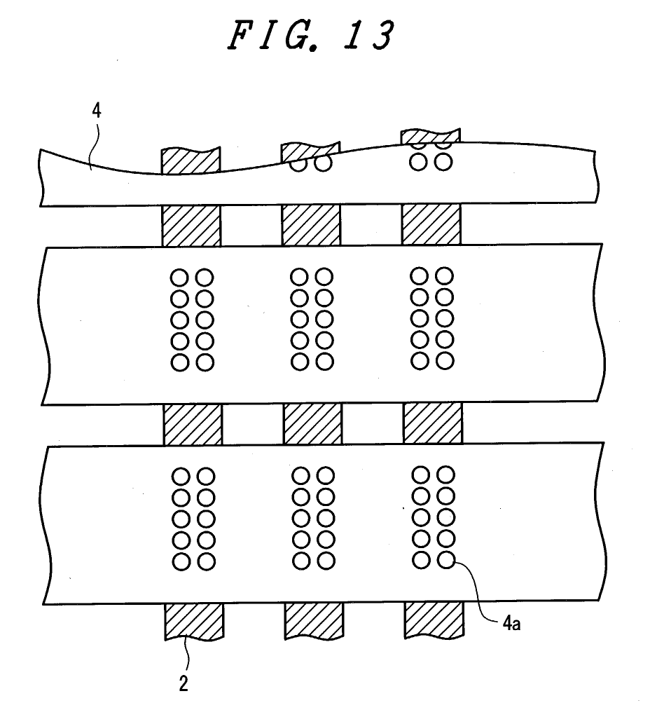

FIG. 13 is a plan view for explaining the arrangement of the cathode lines and plate-like control electrodes formed on the back panel. As shown in FIG. 13, the plate-like control electrodes 4 are arranged at an interval with respect to the cathode lines 2. Accordingly, the cathode lines 2 are exposed between the neighboring plate-like control electrodes 4. The exposed portions of the cathode lines 2 are directly exposed to the anodes formed on an inner surface of a front substrate which constitutes a front panel not shown in the drawing.

Accordingly, when the electron sources such as carbon nanotubes (CNT) are attached to the exposed portions, this causes a so-called stray discharge such as a diode operation. Particularly, in assembling the plate-like control electrodes 4 in the display device, there may be a case that the plate-like control electrodes 4 are brought into contact with the carbon nanotubes in a powdery form formed on the cathode lines 2 and hence, the carbon nanotubes are peeled off and are liable to be easily adhered to the above-mentioned exposed portions.

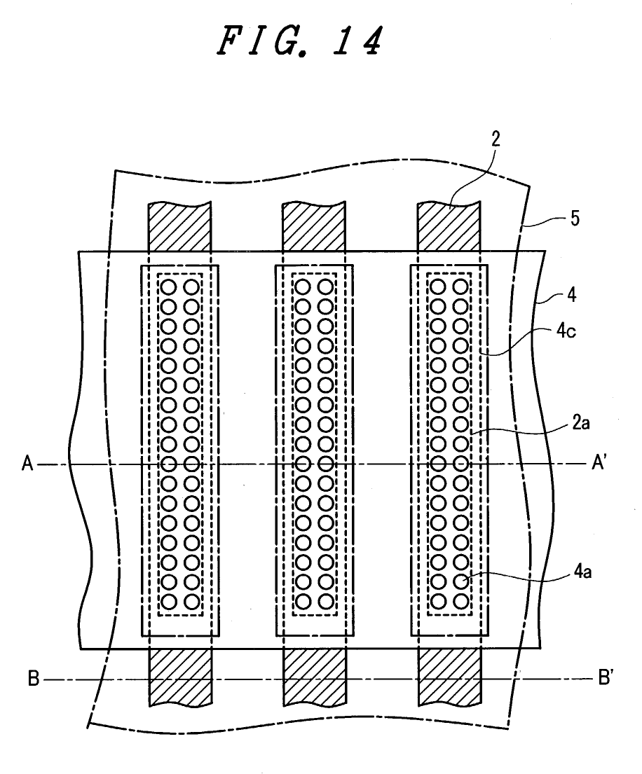

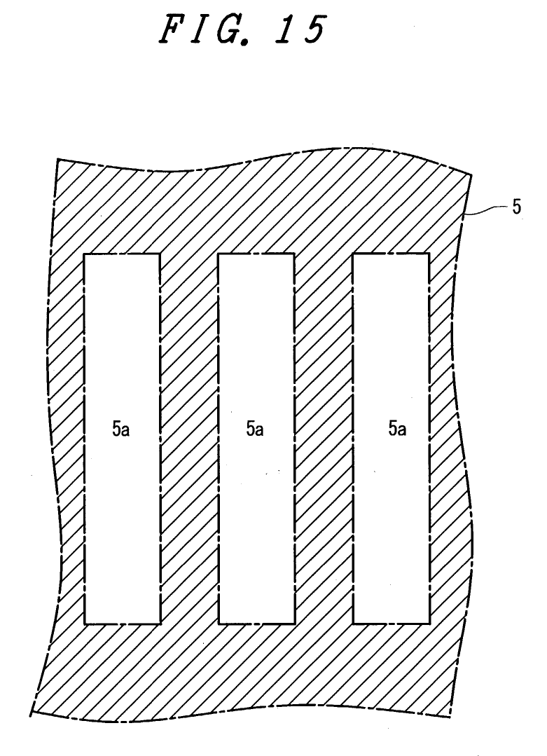

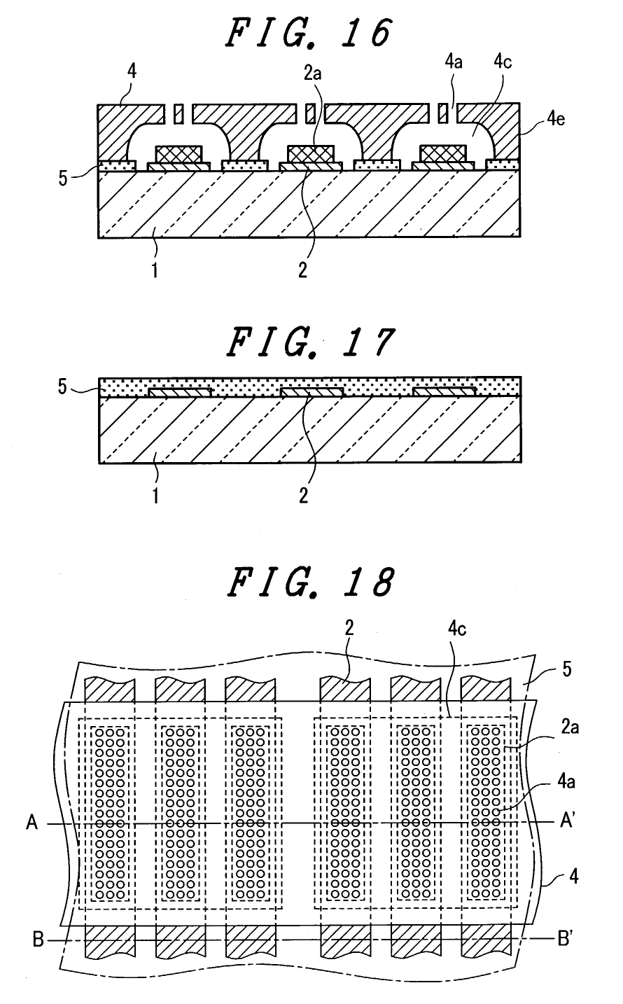

FIG. 14 is a plan view of a back panel side for explaining the constitution of another embodiment of the display device of the present invention. Numerals in FIG. 14 which are equal to those in the drawings of the above-mentioned respective embodiments indicate identical parts. In this embodiment, except for regions where the cathode lines 2 and the plate-like control electrodes 4 cross each other and the electron sources 2a are formed (or in the vicinity of such regions), an insulation covering layer 5 which covers the cathode lines 2 is provided. FIG. 15 is a plan view showing the insulation covering layer 5 by only taking out the insulation covering layer 5 from FIG. 14. FIG. 16 is a cross-sectional view taken along a line A-A′ in FIG. 14. FIG. 17 is a cross-sectional view taken along a line B-B′ in FIG. 14.

As shown in FIG. 15, the insulation covering layer 5 is formed except for the regions 5a where the electron sources 2a are formed (or in the vicinity of such regions). Here, it is sufficient for the insulation covering layer 5 to cover at least portions of the cathode lines 2 which are exposed through the gaps between the plate-like control electrodes 4. Due to such a constitution, even when the electron sources 2a such as carbon nanotubes are attached to the cathode lines 2 between the neighboring plate-like control electrodes 4, it is possible to prevent the stray discharge.

Further, as shown in FIG. 16 and FIG. 17, with respect to the insulation covering layer 5, when the plate-like control electrode 4 has recessed portions 4c at the cathode line 2 side thereof, it is possible to set the distance between the plate-like control electrode 4 and the cathode line 2 to a given value by adjusting a thickness between the first protrusions 4e and the back substrate 1 or a thickness between the second protrusions 4f and the back substrate 1.

Here, when the recessed portions 4c are not formed in the plate-like control electrode 4, it is possible to set the distance between the plate-like control electrode 4 and the cathode lines 2 to a given value by increasing a thickness of the insulation covering layer 5 or by fixing the plate-like control electrode 4 and the cathode lines 2 to each other using the above-mentioned strip-like adhesive agent layers 3 or the like.

Here, the insulation covering layers 5 may be substituted by the strip-like adhesive agent layers 3X, 3Y or the dielectric insulation layer 3X′, 3Y′ used in the above-mentioned respective embodiments.

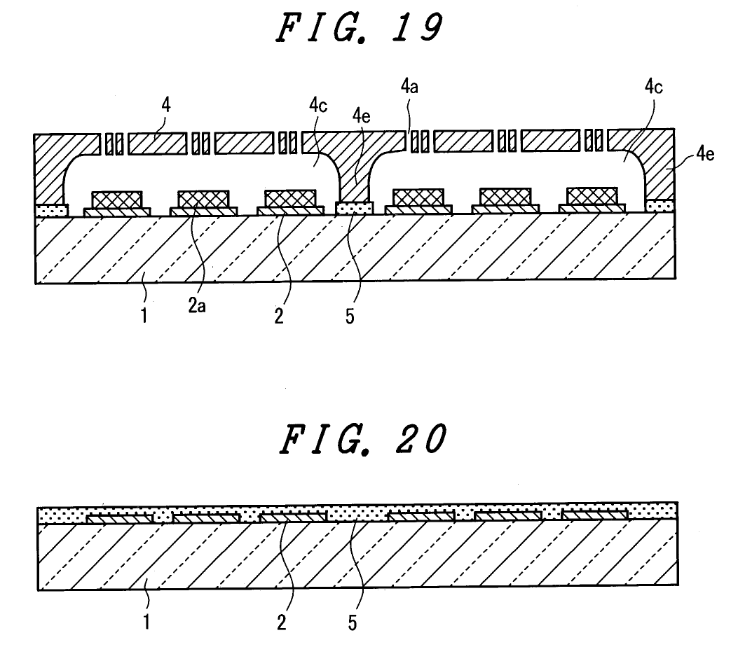

FIG. 18 is a plan view of a back panel side for explaining the constitution of another embodiment of the display device of the present invention. FIG. 19 is a cross-sectional view taken along a line A-A′ in FIG. 18. FIG. 20 is a cross-sectional view taken along a line B-B′ in FIG. 18. Numerals in FIG. 18 to FIG. 20 which are equal to those in the above-mentioned respective embodiments indicate identical parts. This embodiment is characterized in that each recessed portion 4c which is formed in the plate-like control electrode 4 shown in FIG. 14 to FIG. 17 has a size which allows the recessed portion 4c to include three cathode lines 2 as one group, and an insulation covering layer 5 similar to the insulation covering layer 5 shown in FIG. 14 to FIG. 17 is formed over the cathode lines 2.

The manner of operation and the advantageous effects of the insulation covering layer 5 obtained by this embodiment are similar to those of the embodiment shown in FIG. 14 to FIG. 17. Here, although three cathode lines 2 which constitute one color pixel are formed into one group, the present invention is not limited to such a case. That is, it is possible to form two cathode lines 2 into one group or four or more cathode lines 2 into one group. Still further, the number of cathode lines 2 which constitute each group can be set at random. The advantageous effects obtained by these constitutions are also similar to those of the embodiments which have been explained previously.

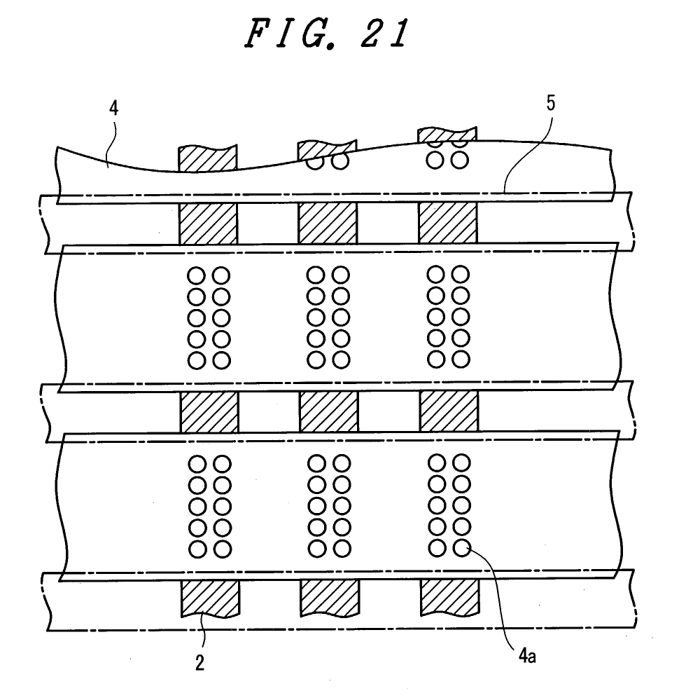

FIG. 21 is a plan view of a back panel side for explaining the constitution of another embodiment of the display device according to the present invention. This embodiment is directed to another constitutional example of the insulation covering layer 5 for preventing the stray discharge from the cathode lines 2 which are exposed through between the neighboring plate-like control electrodes 4. In this embodiment, the insulation covering layer 5 is formed such that the insulation covering layer 5 covers at least the exposed portions of the cathode lines 2 between the neighboring plate-like control electrodes 4. Here, by forming the insulation covering layer 5 such that the insulation covering layer 5 not only covers the exposed portion of the cathode line 2 but also has portions thereof slightly extended and disposed below the plate-like control electrodes 4, the stray discharge which is generated by an electric field generated around between the plate-like control electrodes 4 and the cathode lines 2 can be also effectively suppressed.

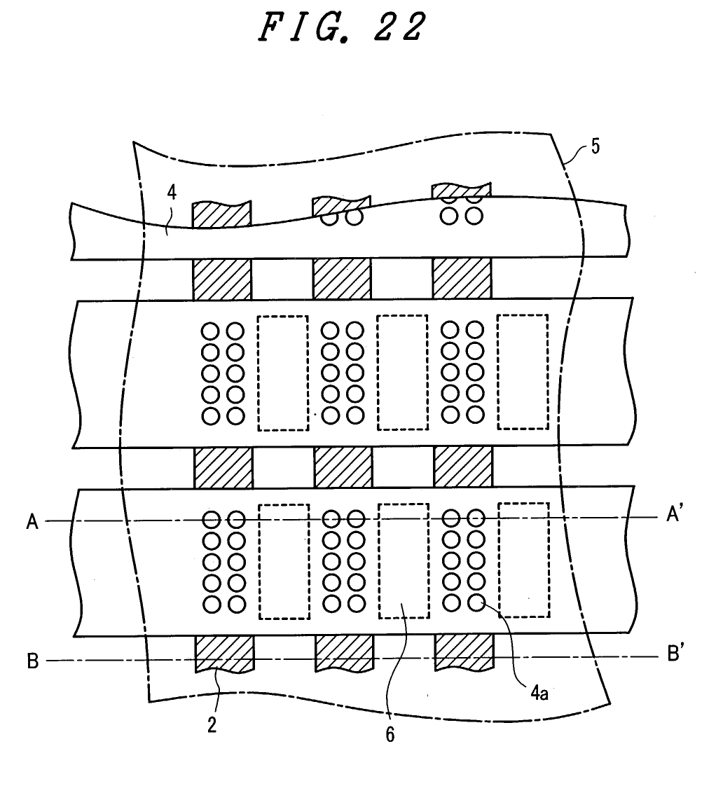

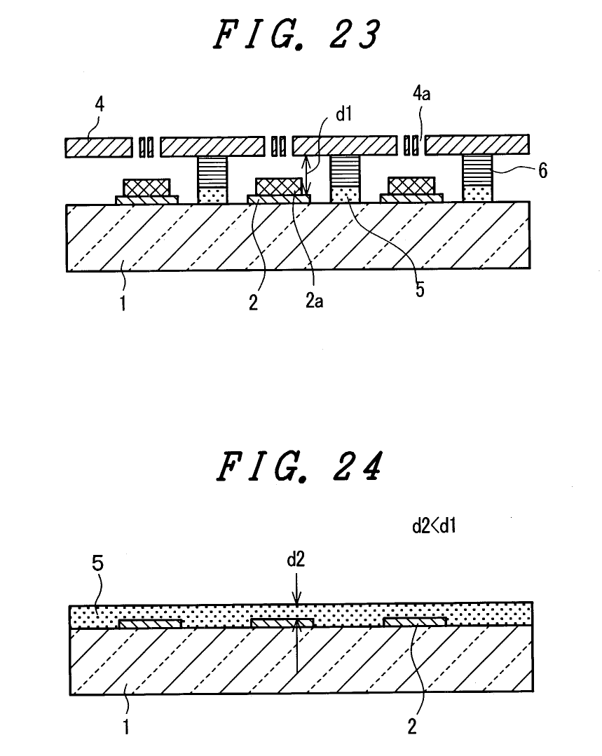

FIG. 22 is a plan view of a back panel side for explaining the constitution of another embodiment of the display device according to the present invention. FIG. 23 is a cross-sectional view taken along a line A-A′ in FIG. 22. FIG. 24 is a cross-sectional view taken along a line B-B′ in FIG. 22. Numerals in FIG. 22 to FIG. 24 which are equal to those in the above-mentioned respective embodiments indicate identical parts. This embodiment is directed to one constitutional example of an insulation covering layer 5 for preventing the stray discharge when the plate-like control electrodes 4 having no recessed portions are adopted.

This embodiment is characterized in that the insulation covering layer 5 similar to the insulation covering layer 5 which has been explained in conjunction with FIG. 14 to FIG. 17 is provided to the display device having the plate-like control electrodes 4 having no recessed portions at the cathode line 2 side. Further, in this embodiment, by arranging support columns 6 between the plate-like control electrodes 4 and the back substrate 1, the plate-like control electrodes 4 are supported on the back substrate 1 while holding a given distance between the plate-like control electrodes 4 and the cathode lines 2.

Throughout FIG. 14 to FIG. 21, a thickness of the insulation covering layer 5 is sufficient so long as the insulation covering layer 5 can prevent the stray discharge and hence, the insulation covering layer 5 may be made thin depending on the magnitude of the stray discharge.

In this embodiment, assuming a distance from a surface of the cathode line 2 to the plate-like control electrode 4 as d1 and a thickness of the insulation covering layer 5 over the cathode line 2 in a region where the cathode line 2 and the plate-like control electrode 4 do not cross each other as d2 in FIG. 23 and FIG. 24, the relationship between the distance d1 and the thickness d2 is set as d2<d1. Here, the distance d2 between the plate-like control electrode 4 and the cathode line 2 is set by the support columns 6. The insulation covering layers 5 may be interposed at portions of the support columns 6. Alternatively, the thickness of the insulation covering layers 5 may be increased by an amount of the support columns 6 by eliminating the support columns 6. Further, The support columns 6 may be provided such that they are fixed to the plate-like control electrode 4 side.

In the display device which fixes the support columns 6 to the plate-like control electrodes 4, the plate-like control electrodes 4 have the similar shape as the above-mentioned plate-like control electrodes 4 having the recessed portions 4c. Here, the cathode lines 2 are formed into a plurality of groups and the support column 6 is interposed between the neighboring groups.

In the respective embodiments which have been described heretofore, with respect to the inventions directed to the insulation covering layer 5, the shape of the plate-like control electrodes 4 includes a shape which has all of the recessed portions 4c, the first protrusions 4e and the second protrusions 4f as well as a shape which lacks in at least any one of these recessed portions 4c and the protrusions 4e, 4f. Further, the plate-like control electrodes 4 may be combined with the strip-like adhesive agent layers 3X, 3Y or the dielectric insulation layers 3X′, 3Y′.

The relationship d2<d1 is not limited to the plate-like control electrodes 4 which use the support columns 6. That is, the relationship is applicable to the plate-like control electrodes 4 which have at least one of the recessed portions 4c, the first protrusions 4e and the second protrusions 4f. Further, the relationship d2<d1 may be combined with the grouping of the cathode lines 2.

The respective embodiments which have been explained heretofore may be combined with each other.

The plate-like control electrodes 4 according to the present invention is preferably made of an iron alloy (for example, 42%Ni—6%Cr—balance of Fe). However, the material of the plate-like control electrodes 4 is not limited to such an iron alloy. The electron passing holes 4a and the recessed portions 4c are formed by etching. With respect to the plate-like control electrode 4 having the recessed portions 4c, first of all, by performing etching in two stages such that the recessed portions 4c are firstly formed by etching and the electron passing holes 4a are formed by etching thereafter, it is possible to accurately form the minute electron passing holes 4a even when the thickness of the plate is large. The electron passing holes 4a and the recessed portions 4c may be formed in a manner opposite to the above-mentioned manner. Both of the electron passing holes 4a and the recessed portions 4c may be formed simultaneously from both surfaces of the plate-like control electrode 4 by etching.

Although the electron passing holes 4a formed in the plate-like control electrode 4 have been explained as a large number of circular holes which are arranged in a square form, the present invention is not limited to such an arrangement. That is, the electron passing holes 4a may be arranged in a delta arrangement and the number of the electron passing holes 4a is not limited to the number shown in the drawings. Further, the shape of holes may have a shape other than a circular shape.

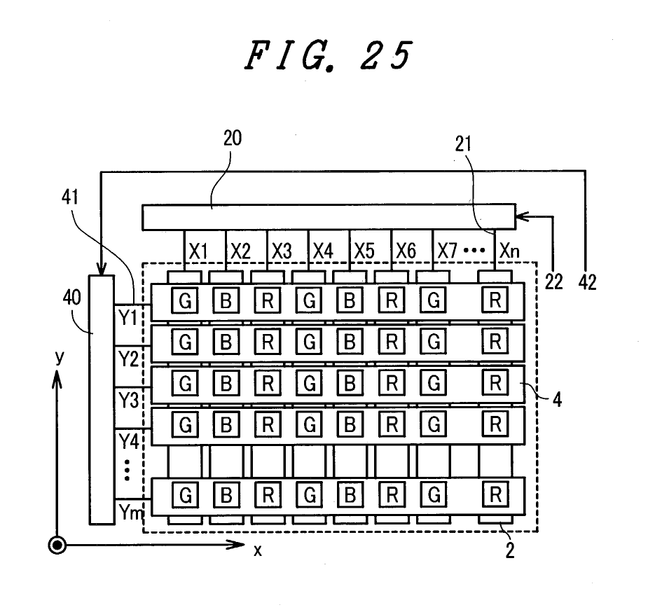

FIG. 25 shows an equivalent circuit for explaining one example of a driving method of the display device according to the present invention. In this display device, n pieces of cathode lines 2 which extend in the y direction are arranged in parallel in the x direction. Further, m pieces of control electrodes 4 which extend in the x direction are arranged in parallel in the y direction thus forming a matrix of m rows and n columns together with the cathode lines 2.

In a periphery of the back panel which constitutes this display device, a scanning circuit 40 and a video signal circuit 20 are arranged. The scanning circuit 40 is connected to the respective plate-like control electrodes 4 through control electrode terminals 41 (Y1, Y2, . . . Ym). On the other hand, the video signal circuit 20 is connected to the respective cathode lines 2 through cathode terminals 21 (X1, X2, . . . Xn).

The electron sources 2a which have been explained in the previous embodiments are provided for respective pixels arranged in a matrix array. In the drawings, R, G, B respectively indicate red, green and blue pixels and these pixels R, G, B make the phosphors emit lights corresponding to respective colors.

A synchronous signal 42 is inputted to the scanning circuit 40. The scanning circuit 40 is connected to the control electrodes 4 through the control electrode terminals 41 and applies a scanning signal voltage to the control electrodes 4 by selecting the rows of the matrix.

On the other hand, a video signal 22 is inputted to the video signal circuit 20. The video signal circuit 20 is connected to the cathode lines 2 through the cathode terminals 21 (X1, X2, . . . Xn) and applies a voltage corresponding to the video signal 22 to the selected cathode line 2 after selecting the row of the matrix. Due to such a constitution, given pixels which are sequentially selected by the control electrodes 4 and the cathode lines 2 emit light in given colors whereby a two-dimensional image is displayed. With the provision of the display device having such a constitutional example, a flat-panel type display device of a relatively low voltage and a high efficiency can be realized.

As has been explained heretofore, according to the present invention, it is possible to control the distance between the plate-like control electrodes 4 and the cathode lines 2 with high accuracy so that the uniform display having the uniform luminance over a whole surface of the display region can be obtained. Further, even when the electron sources are attached to the cathode lines 2 which are exposed through between the neighboring plate-like control electrodes 4, it is possible to prevent the occurrence of the stray discharge at the exposed portion whereby it is possible to provide the display device which can obtain the display of high quality.

What is claimed is:

1. A display device comprising:
a back panel including a back substrate, a plurality of cathode lines which are formed on an inner surface of the back substrate, have electron sources and extend in a first direction, and a plurality of control electrodes in which electron passing holes which allow electrons emitted from the electron sources to pass therethrough are formed, which are not in contact with the cathode lines, extend in a second direction which crosses the first direction and control electron emission characteristics of the electron sources; and
a front panel including a front substrate and anodes and phosphors formed on an inner surface of the front substrate which faces the back substrate, wherein
the control electrodes are plate-like control electrodes, and
the back panel includes strip-like adhesive agent layers which are provided in regions between a plurality of cathode lines and between the back substrate and the plate-like control electrodes, and fix the plate-like control electrodes with holding a given distance between the plate-like control electrode and the cathode lines, and the strip-like adhesive agent layers extend in the first direction and fix at least two out of the plurality of plate-like control electrodes in common.

2. A display device according to claim 1, wherein the plate-like control electrode includes first protrusions which protrude toward the back substrate side at portions corresponding to positions between the neighboring cathode lines, and
at least some of the strip-like adhesive agent layers are formed between the first protrusions and the back substrate.

3. A display device according to claim 1, wherein the plate-like control electrode includes second protrusions which protrude toward the back substrate side at peripheral portions thereof along the second direction.

4. A display device according to claim 3, wherein the back panel includes strip-like adhesive agent layers which extend in the second direction between the back substrate and the second protrusions.

5. A display device comprising:
a back panel including a back substrate, a plurality of cathode lines which are formed on an inner surface of the back substrate, have electron sources and extend in a first direction, and a plurality of control electrodes in which electron passing holes which allow electrons emitted from the electron sources to pass therethrough are formed, which are not in contact with the cathode lines, extend in a second direction which crosses the first direction and control electron emission characteristics of the electron sources; and
a front panel including a front substrate and anodes and phosphors formed on an inner surface of the front substrate which faces the back substrate, wherein
the control electrodes are plate-like control electrodes, include recessed portions which reduce a thickness of the plate-like control electrodes at cathode-line-side regions where the electron passing holes are formed, and include peripheral protrusions which protrude toward the back substrate side at peripheral portions along the second direction, and
the back panel includes strip-like adhesive agent layers which are provided between the back substrate and the peripheral protrusions, and extend in the second direction and fix the plate-like control electrodes with holding a given distance between the plate-like control electrode and the cathode lines.

6. A display device according to claim 5, wherein the strip-like adhesive agent layers which extend in the second direction are formed in common with respect to the neighboring plate-like control electrodes.

7. A display device according to claim 5, wherein the plate-like control electrodes include inter-cathode-line protrusions which protrude toward the back substrate side at portions thereof corresponding to positions between the neighboring cathode lines.

8. A display device according to claim 5, wherein the strip-like adhesive agent layer which extends in the first direction is formed between the neighboring cathode lines.

9. A display device according to claim 1, wherein insulation layers are formed between the strip-like adhesive agent layers and the back substrate.

10. A display device comprising:
a back panel including a back substrate, a plurality of cathode lines which are formed on an inner surface of the back substrate, have electron sources and extend in a first direction, and a plurality of control electrodes in which electron passing holes which allow electrons emitted from the electron sources to pass therethrough are formed, which are not in contact with the cathode lines, extend in a second direction which crosses the first direction and control electron emission characteristics of the electron sources; and
a front panel including a front substrate and anodes and phosphors formed on an inner surface of the front substrate which faces the back substrate, wherein
the control electrodes are plate-like control electrodes, and
the back panel includes an insulation covering layer which covers portions of the cathode lines which are exposed through between the plurality of plate-like control electrodes.

11. A display device according to claim 10, wherein assuming a distance from a surface of the cathode line to the electron passing holes formed in the plate-like control electrode at a region where the cathode line and the plate-like control electrode crosses as d1 and a thickness of the insulation covering layer over the cathode lines in a region other than the region where the cathode line and the plate-like control electrode crosses as d2, a relationship d2<d1 is established.

12. A display device according to claim 10, wherein the plate-like control electrode includes first protrusions which protrude toward the back substrate side at portions thereof corresponding to positions between the neighboring cathode lines and the first protrusions hold a distance between the cathode lines and the electron passing holes.

13. A display device according to claim 10, wherein the plate-like control electrode includes second protrusions which protrude toward the back substrate side at peripheral portions thereof along the second direction and the second protrusions hold a distance between the cathode lines and the electron passing holes.

14. A display device according to claim 10, wherein the back panel includes support column members which hold the plate-like control electrodes with respect to the back substrate with a given distance in regions between the cathode lines formed on the back substrate.
